(19) United States
(12) Patent Application Publication
(10) Pub. No.: US 2024/0346362 A1
(43) Pub. Date: Oct. 17, 2024

(54) ABSTRACTING COMPUTER-BASED INTERACTION(S) FOR AUTOMATION OF TASK(S)

(71) Applicant: X Development LLC, Falls Church, CA (US)

(72) Inventors: David Andre, San Francisco, CA (US); Garrett Raymond Honke, Mountain View, CA (US)

(73) Assignee: Electra Aero, Inc., Falls Church, VA (US)

(21) Appl. No.: 18/135,043

(22) Filed: Apr. 14, 2023

(51) Int. Cl. G06N 20/00

(52) U.S. Cl. CPC G06N 20/00

(57) ABSTRACT

Disclosed implementations relate to preserving individuals' semantic privacy while facilitating automation of tasks across a population of individuals. In various implementations, data indicative of an observed set of interactions between a user and a computing device may be recorded and used to simulate multiple different synthetic sets of interactions between the user and the computing device. Each synthetic set may include a variation of the observed set of interactions at a different level of abstraction. User feedback may be obtained about each of the multiple different sets. Based on the user feedback, one of the multiple different synthetic sets of interactions may be selected and used to train a machine learning model.

### BACKGROUND

Individuals often operate computing devices to perform tasks that are likely to be replicated by others to various degrees. For example, an individual may engage in a sequence of actions using a first computer application to perform a given task, such as setting various application preferences, retrieving/viewing particular data that is made accessible by the first computer application, performing a sequence of operations within a particular domain (e.g., 3D modeling, graphics editing, word processing), and so forth. A different individual may later engage in a semantically similar sequence of actions to perform a semantically similar task in a different context, such as while using a different computer application, or while using the same type of computer application but with a different purpose. Repeatedly performing the actions that comprise these tasks may be cumbersome, prone to error, and may consume computing resources and/or the individual's attention unnecessarily.

### SUMMARY

Implementations are described herein for preserving individuals' semantic privacy while facilitating automation of tasks across a population of individuals. More particularly, but not exclusively, implementations are described herein for enabling individuals (often referred to as “users”) to adjust levels of abstraction associated with captured (e.g., recorded, observed) sequences of computer-based interactions (e.g., user inputs, rendered outputs), prior to those captured sequences of computer-based interactions being leveraged to automate performance of task(s) across the population.

In some implementations, a method may be implemented using one or more processors and may include: sampling a plurality of interactions between a user and a computer application, wherein the interactions are collectively associated with the user performing a high-level task; encoding the plurality of interactions into one or more task embeddings at a first level of abstraction; processing one or more of the task embeddings using a private machine learning model to simulate, for the user via one or more output devices, performance of the high-level task at the first level of abstraction; based on user input rejecting the first level of abstraction, training the private machine learning model, wherein the training generates an updated private machine learning model; and providing parameters of the updated private machine learning model for federated learning of a global machine learning model.

In various implementations, the method may include: in response to the user input rejecting the first level of abstraction, encoding the plurality of interactions into one or more second task embeddings at a second level of abstraction that is different than the first level of abstraction; and prior to the training, processing one or more of the second task embeddings using the private machine learning model to simulate, for the user via one or more of the output devices, performance of the high-level task at the second level of abstraction.

In various implementations, the simulated performance of the high-level task at the second level of abstraction may exclude one or more interactions of the sampled plurality of interactions. In various implementations, the simulated performance of the high-level tasks at the second level of abstraction may excludes or obfuscate one or more pieces of information that was input by, or output to, the user during the sampling. In various implementations, a different softmax layer temperature may be used to encode the first task embedding(s) than is used to encode the second task embedding(s).

In various implementations, the providing may include providing data indicative of a local gradient to a remote computing system that maintains the global machine learning model. In various implementations, the private machine learning model may be a transformer. In various implementations, the private machine learning model may be a large language model (LLM). In various implementations, tokens predicted based on the LLM may correspond to the first plurality of interactions.

In another related aspect, a method may be implemented using one or more processors and include: recording data indicative of an observed set of interactions between a user and a computing device; based on the recorded data, simulating multiple different synthetic sets of interactions between the user and the computing device, wherein each synthetic set comprises a variation of the observed set of interactions at a different level of abstraction; obtaining user feedback about each of the multiple different sets; based on the user feedback, selecting one of the multiple different synthetic sets of interactions; and causing a machine learning model to be trained to generate output indicative of the selected synthetic set of interactions.

In various implementations, the simulating is performed based on the machine learning model. In various implementations, the machine learning model may be trained to facilitate intelligent process automation.

In various implementations, the machine learning model may be trained to generate a probability distribution over an action space. In various implementations, the machine learning model may include a private machine learning model, and the method may further include providing parameters of the trained private machine learning model for federated learning of a global machine learning model.

In addition, some implementations include one or more processors of one or more computing devices, where the one or more processors are operable to execute instructions stored in associated memory, and where the instructions are configured to cause performance of any of the aforementioned methods. Some implementations include at least one non-transitory computer readable storage medium storing computer instructions executable by one or more processors to perform any of the aforementioned methods.

### BRIEF DESCRIPTION OF THE DRAWINGS

FIG. 1 is a diagram of an example environment in which implementations disclosed herein can be implemented.

FIG. 2 schematically illustrates an example of how components of FIG. 1 can interact to automate performance of a task of a user.

FIG. 3 is a flowchart illustrating an example method of practicing selected aspects of the present disclosure, according to implementations disclosed herein.

FIG. 4 is a flowchart illustrating another example method of practicing selected aspects of the present disclosure, according to implementations disclosed herein.

FIG. 5 illustrates an example architecture of a computing device.

### DETAILED DESCRIPTION

Implementations are described herein for preserving individuals' semantic privacy while facilitating automation of tasks across a population of individuals. More particularly, but not exclusively, implementations are described herein for enabling individuals (often referred to as “users”) to adjust levels of abstraction associated with captured (e.g., recorded, observed) sequences of computer-based interactions (e.g., user inputs, rendered outputs), prior to those captured sequences of computer-based interactions being leveraged to automate performance of task(s) across the population.

In various implementations, while a user operates a computing device to perform a high-level task, such as writing a letter, reading a scientific article, editing a digital image, etc., a sequence of computer-based interactions between the user and the computing device may be recorded. These computer-based interactions may include user inputs such keystrokes, pointer device activity, engagement with graphical user interface (GUI) elements, speech inputs, etc., as well as outputs (e.g., audible, visual, haptic, etc.) generated by the computing device.

To enable the user to observe and/or control how sensitive and/or private information will be shared to automate performance of the high-level task for others, variations of these computer-based interactions at different levels of abstraction may then be simulated for the user. Each simulation may include a different synthetic set of computer-based interactions involved in the higher-level task performed previously by the user. Put another way, each synthetic set may include a variation of the observed set of interactions at a different level of abstraction. The user may provide feedback (e.g., accept, reject, modify) in response to each simulation, particularly about the respective level of abstraction (e.g., level of detail of factual information) that is reflected in each simulation.

As an example, suppose a sequence of computer-based interactions are recorded of a user operating a word processing application to write a letter. An initial letter writing simulation presented to the user may automatically populate the recipient's physical address. Assuming the user does not want to share the recipient's address (e.g., because it is private or would not be useful in other contexts), the user may provide feedback (e.g., “no, don't include the recipient address”) that rejects the current/applicable level of abstraction that led to the recipient's address being auto populated. A subsequent letter writing simulation may implement a different level of abstraction by omitting the recipient's address, e.g., by including a generic address placeholder instead. If the user approves the subsequent letter writing simulation, data indicative of the computer-based interactions of the subsequent letter writing simulation may be leveraged to automate the task of letter writing generally, e.g., across a population of users.

High-level tasks may be automated in various ways. In some implementations, a “private” (e.g., local) embedding machine learning model (also referred to herein as an “embedding model”) may be trained to generate embeddings at various levels of abstraction. Additionally or alternatively, a “private” (e.g., local) action machine learning model (also referred to herein as an “action model”) may be trained to generate output indicative of a synthetic sequence of computer-based interactions involved with performance of a high-level task. These private embedding and/or action models may be stored locally at a client device operated by a user, or may be stored in a “private cloud” for which access is controlled by the user. In either case, learned parameters of the private embedding and/or action model may be combined, e.g., with learned parameters of other private embedding and/or action models of other users, to train a “global” or “public” embedding and/or action model as part of a federated learning framework.

Sets of computer-based interactions generated based on (private or global) action models as described herein are referred to as “synthetic” because their constituent computer-based interactions are predicted instead of observed. Consequently, synthetic sets of computer-based interactions will include at least some predicted computer-based interactions that are not identical to the real-life recorded computer-based interactions. More generally, synthetic sets of computer-based interactions may exhibit different levels of abstraction than recorded sets of computer-based interactions. Recorded computer-based interactions that could potentially expose sensitive information (e.g., a social security number) to untrusted parties may be “abstracted” such that the sensitive information is excluded or obfuscated. Similarly, recorded computer-based interactions that may not necessarily expose sensitive information, but are not widely applicable outside of a narrow context, may also be abstracted to be more broadly applicable.

The private or global action model(s) may take various forms. In some implementations, an action model configured with selected aspects of the present disclosure may take the form of a neural network that is trained to generate probability distribution(s) over an action space. Based on these probability distributions, synthetic sets of computer-based interactions may be generated. The action space may be populated with, for instance, computer-based interactions (particularly user inputs) that can be performed using a computing device. To reduce and/or manage the sizes of search spaces, in some implementations, domain-specific action models may be trained to generate probability distributions over action spaces of specific domains, such as for specific computer applications, specific contexts (e.g., various scientific specialties, various positions at organizations), and so forth. As used herein, a “domain” may refer to a targeted subject area in which a computing component is intended to operate, e.g., a sphere of knowledge, influence, and/or activity around which the computing component's logic revolves.

In other implementations, the action model may take the form of a sequence-to-sequence model that generates a sequence of output tokens that correspond to and/or represent a synthetic set of computer-based interactions. A sequence-to-sequence action model may include, for instance, various types of recurrent neural networks (RNNs), such as long short-term memory (LSTM) networks or gated recurrent unit (GRU) networks.

The sequence-to-sequence action model may alternatively include various types of transformer networks, such as the Bidirectional Encoder Representations from Transformers (BERT) transformer or a generative pretrained transformer (GPT). In some implementations, large language models (LLMs), which may also take the form of transformers but with large numbers of parameters, may be used. In some such implementations, beam searching may be performed at various beam widths (which may be selected by the user, e.g., as part of controlling the level of abstraction) in order to generate synthetic sets of computer-based interactions at different levels of abstraction. In some implementations, a sequence of input tokens may represent observed computer-based interactions that actually occurred between a user and a computing device. In various implementations, the output tokens may correspond to and/or represent a synthetic set of computer-based interactions between a user and a computing device.

Levels of abstraction associated with sets of computer-based interactions can be altered in other ways. In some implementations, individual actions may be altered directly, e.g., based on a command received from a user, to alter or exclude data. In the letter writing example described previously, for instance, the user provided feedback—“don't include the recipient address.” As a consequence, natural language processing and/or pattern recognition may be performed on the composed letter to identify the recipient's address, which may then be excluded, obfuscated, replaced with a generic placeholder, etc., before being tokenized (e.g., converted into a domain specific language (DSL) and/or embedding(s)) and applied as input(s) across action model(s).

As another example, individual computer-based interactions may be altered, e.g., symbolically and/or using various metaheuristics (e.g., simulated annealing, genetic algorithm), to be more generally applicable. Suppose a physics expert is reading a digital paper about biology, and that the physics expert receives, e.g., from a virtual assistant automatically or by request, clarifications (e.g., definitions, acronyms) of various biological terms contained in the digital paper. These clarifications may be presented to the physics expert in various ways, such as computer-generated speech and/or text of the virtual assistant, annotations in the margins, pop-up windows that highlight the terms being clarified, etc. The interactions between the physics expert, an application that renders the digital paper, the clarified biological terms, the virtual assistant, and/or the computing device at large may be recorded. In some implementations, contextual data may be recorded as well, such as the fact that an expert in one domain (e.g., physics) is consuming media (the digital paper) from another domain (e.g., biology) in which they are not expert.

Some of these recorded computer-based interactions may be abstracted so that they are applicable outside of the particular context in which they were recorded. For example, clarifying a specific biological term to the physics expert may not be applicable in another context where, for instance, a biology expert is reading a digital paper about computer science. Accordingly, one or more computer-based interactions that collectively resulted in a biological term being clarified to the physics expert may be abstracted into, for instance, a symbolic template that more broadly causes suitable terms or phrases in any domain to be clarified to an individual who is not expert in that domain.

In some implementations, words or phrases may be identified as suitable for clarification based on metrics such as word length, word frequency (e.g., calculated using term frequency-inverse document frequency, or “TF-IDF”), etc. Suppose the biological terms for the physics expert sought clarification have TF-IDF scores that fall above a particular threshold, are within a range, etc. The resulting symbolic template may be created to clarify terms or phrases in any domain with similar TF-IDF scores. In some implementations, the symbolic template may then be tokenized (e.g., converted into a DSL and/or embedding(s)) and applied as input across the action model.

Another way to alter a level of abstraction of a (observed or synthetic) set of computer-based interactions is to reduce a dimensionality of tokens (e.g., a vector/feature embedding, DSL, etc.) that encode the set computer-based interactions. In some implementations, a recorded sequence of computer-based interactions may be tokenized/encoded, e.g., using one or more of the aforementioned private embedding models (e.g., obtained from encoder-decoder machine learning models), into embedding(s) of x (positive integer) dimensions. Should a user request a higher level of abstraction, dimensionality reduction may be performed to encode the x-dimension embedding(s) into new embedding(s) of y dimensions, with y being a positive integer that is less than x. In some such implementations, the dimensionality reduction may be lossy to prevent reconstruction of information that the user intended to protect. Processing the y-dimension embeddings using an action model configured with selected aspects of the present disclosure may yield a synthetic set of computer-based interactions that is more abstract than what is represented by the x-dimension embedding(s). In some implementations, fuzzy semantic privacy may be employed to make it difficult or impossible to recreate, at least probabilistically, a user's original scenario. For example, various types of transformers may be applied to data indicative of recorded actions of a user to create a new sequence of recorded actions. This new synthetic sequence of actions may be similar to the user's original actions, but different in the particulars (e.g., values).

Yet another way to alter a level of abstraction of a set of computer-based interactions is to adjust one or more hyperparameters of the action model itself. As one example, the temperature of the action model's softmax layer may be adjusted to alter probability distribution(s) generated by the action model. A “higher” temperature may yield probability distribution(s) that are “softer,” less confident, and/or more uniform, whereas a “lower” temperature may yield probability distribution(s) that are “harder,” more confident, and/or less uniform. Stochastically sampling from the former may yield more variation (and hence, a different level of abstraction) than the latter.

As another working example, assume that a user is editing a digital image using an image editing application. Assume further that the user performs particular actions on the images, such as removing noise, cropping the image, converting the image to a particular resolution (e.g., reduced resolution for viewing on a display, as opposed to printing), etc. In various implementations, the user may be presented with one or more simulations demonstrating variations of these actions at different levels of abstraction being performed, e.g., on the same image, on a different image, or without an image at all. In the last case, the user may be presented with the actions as conceptual objects with adjustable attributes that correspond to parameters of what the user implemented on the real image. The user may be able to specify values for these parameters in order to create a suitable abstraction for generalization. Additionally or alternatively, in some implementations, the user may specify, e.g., using natural language, qualities of the image that should dictate these parameters. For example, suppose the user manually cropped the image to hone in on a person depicted in the image while excluding unwanted background. The user could provide, e.g., as feedback in response to a subsequent simulation, a natural language annotation such as “crop to within one cm of the subject's face in all directions.”

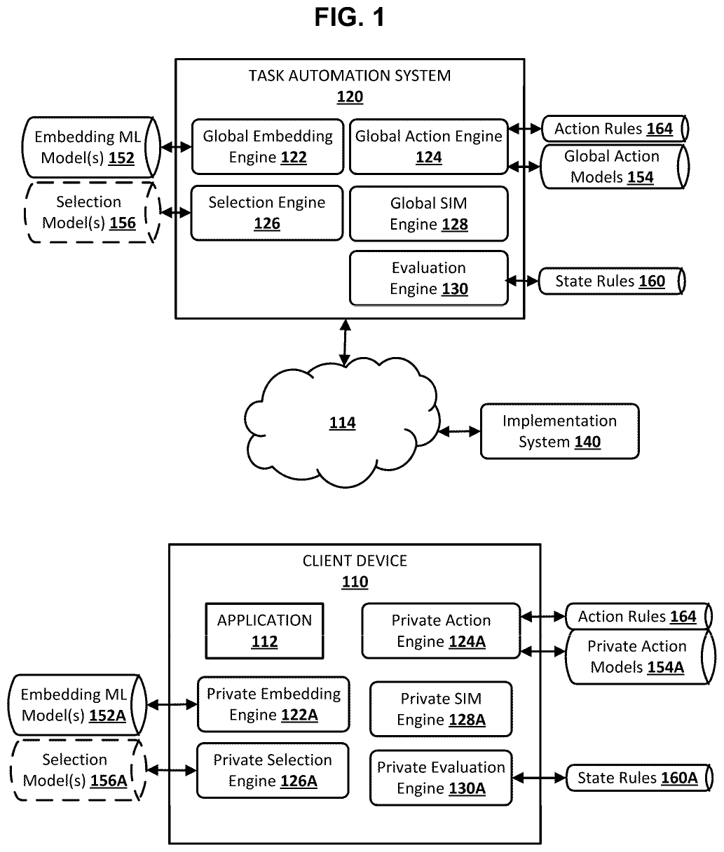

FIG. 1 schematically depicts an example environment in which selected aspects of the present disclosure can be implemented, in accordance with various implementations. Any computing devices depicted in FIG. 1 or elsewhere in the figures can include logic such as one or more microprocessors (e.g., central processing units or “CPUs”, graphical processing units or “GPUs”, tensor processing units or (“TPUs”)) that execute computer-readable instructions stored in memory, or other types of logic such as application-specific integrated circuits (“ASIC”), field-programmable gate arrays (“FPGA”), and so forth. Some of the systems depicted in FIG. 1, such as task automation system 120, can be implemented, in whole or in part, using one or more server computing devices that form what is sometimes referred to as a “cloud infrastructure,” although this is not required.

The task automation system 120 can be operably coupled with one or more client computing devices (also referred to herein as “client(s)”), such as client computing device 110, via one or more computer networks 114. The task automation system 120 can automatically determine sets of computer-based interactions to utilize in attempting automation of higher-level tasks that are performed by users of client devices (e.g., 110).

An individual (which in the current context may also be referred to as a “user”) may operate client device 110 to interact with other components depicted in FIG. 1. Each client device 110 may be, for example, a desktop computing device, a laptop computing device, a tablet computing device, a mobile phone computing device, a computing device of a vehicle of the participant (e.g., an in-vehicle communications system, an in-vehicle entertainment system, an in-vehicle navigation system), a standalone interactive speaker (with or without a display), or a wearable apparatus that includes a computing device, such as a head-mounted display (“HMD”) that provides an AR or VR immersive computing experience, a “smart” watch, and so forth. Additional and/or alternative client devices may be provided.

Examples described herein generally relate to users operating computing devices such as client device 110 to record sequences of computer-based interactions that are automated. However, this is not meant to be limiting. A sequence of computer-based interactions may also include interactions with other types of computing devices. For example, when a driver operates a vehicle equipped with various in-vehicle circuitry and/or logic configured with selected aspects of the present disclosure, interactions between the driver and the vehicle may be recorded. Later, those interactions may be simulated at different levels of abstraction, e.g., for the driver or for another individual (e.g., someone tasked to train one or more machine learning models). Based on those simulations, feedback may be provided that allows at least some of the driving interactions that would be applicable outside of the particular context in which the driver originally operated the vehicle to be automated. For example, the interactions engaged in by the driver while parallel parking between two vehicles may be recorded and abstracted to allow parallel parking between any two structures.

The client device 110 can include one or more applications, such as application 112, that interact with the task automation system 120. For example, the application 112 can be one via which inputs of a user can be provided, and which output(s) generated by the task automation system 120 can be rendered to the user, such as output(s) requesting user feedback (e.g., output(s) that reflect a final state of a simulation of a candidate interaction set) and/or output(s) that reflect a set of computer-based interactions determined by the task automation system 120 (e.g., for confirmation of the set automation). In some implementations, where the task includes control of a computer application executing on the client 110, the application 112 (or another application) can be one that can be controlled using a synthetic set of computer-based interactions determined by the task automation system 120.

In various implementations, task automation system 120 includes a global embedding engine 122, a global action engine 124, a global selection engine 126, a global simulation (SIM) engine 128, and/or a global evaluation engine 130. Although task automation system 120 is depicted in FIG. 1 as connected to the client 110 via the network(s) 114, in various implementations one or more aspects of task automation system 120 can be combined and/or can be implemented locally at the client 110. For example, one or more of the engines of task automation system 120 may be implemented additionally or alternatively at client 110. For example, client 110 includes a private embedding engine 122A, a private action engine 124A, a private selection engine 126A, a private SIM engine 128A, and/or a private evaluation engine 130A. Additionally or alternatively, in some implementations, all or portions of task automation system 120 may be implemented in a private cloud (not depicted) controlled by a user, so that the virtually limitless resources of the cloud can be leveraged without compromising the user's individual privacy or security.

Public embedding engine 122 and/or private embedding engine 122A can interface with one or more public and/or private embedding ML models 152, 152A in generating embeddings described herein. Which embedding ML model(s) 152/152A embedding engine 122/122A interfaces with, and/or the data it processes in interfacing with one or more of the embedding ML model(s) 152/152A, can be dependent on the embedding technique(s) that are being utilized by embedding engine 122/122A.

For example, for a given NL input embedding engine 122/122A can generate an embedding based on a first embedding technique that is processing NL input data, that reflects the NL input, using a domain specific LLM model of the embedding models 152/152A. For various types of computer-based interactions, embedding engine 122/122A can generate embedding(s) based on a second embedding technique that includes processing computer-based interactions using some other domain-specific model.

The embedding technique(s) being utilized at a given instance by embedding engine 122/122A can be dependent on various factors and, in some implementations, can be dictated by the selection engine 126/126A. For example, the embedding technique(s) utilized can be dependent on a domain of the task, computer-based interactions for which embedding(s) are being generated, and/or the action model(s) 154/154A being utilized by the action engine 124/124A in generating candidate synthetic set(s) of computer-based interactions. Various embedding ML models 152/152A can be provided. For example, embedding ML models 152/152A can include those that are specific to a particular domain, those that are specific to a set of particular domains, and/or those that are domain agnostic. As another example, embedding ML models 152/152A can additionally or alternatively include those specific to a first type of data (e.g., natural language data), those specific to a second type of data (e.g., computer-based interactions), and so on.

Global action engine 124 can interface with one or more global (or “public”) action models 154 in facilitating automation of sets of computer-based interactions. In some implementations, one or more global action models 154 may be trained to facilitate robotic process automation and/or intelligent process automation. Similarly, private action engine 124A can interface with one or more private action models 154A in facilitating automation of sets of computer-based interactions while maintaining user privacy. In some implementations, action engine 124/124A also interfaces with one or more action rules 164/164A, which can be used to eliminate some generated candidate synthetic set(s) of computer-based interactions from further consideration (e.g., from further consideration by the evaluation engine 130/130A). The action rules 164/164A can be specific to a domain and/or specific to a corresponding requesting entity, such as a user or an organization associated with the user. For example, for a particular domain and a particular organization, a given action rule can define that a given action is not allowed at all or is not allowed if it occurs before or following certain other action(s).

Which action model(s) 154/154A the action engine 124/124A interfaces with at a given instance can be dependent on various factors and, in some implementations, can be dictated by the selection engine 126/126A. For example, the action model(s) 154/154A utilized can be dependent on a domain of the task, the input for which embedding(s) are being generated, and/or the embedding(s) being generated by embedding engine 122/122A. Also, for example, the action model(s) 154/154A utilized in a given instance for an input can additionally or alternatively be based on action model(s) utilized in prior instance(s) in generating candidate synthetic set(s) of computer-based interactions for the input and/or evaluations(s) of those candidate synthetic set(s).

Various action models 154/154A can be provided. For example, action models 154/154A can include machine learning models and/or heuristic models. As another example, action models 154/154A can include those that are specific to a particular domain, those that are specific to a set of particular domains, and/or those that are domain agnostic. As another example, action models 154/154A can include: those that represent an reinforcement learning (RL) policy and are utilized to generate a candidate synthetic set of computer-based interactions by iteratively generating a corresponding next action of the candidate synthetic set based on applying updated state data at each iteration; those that are utilized to generate, in a single iteration, one or more candidate synthetic sets of computer-based interactions; those that represent a value function and are utilized to generate a measure that reflects the value of a set of computer-based interactions, current state pair; and/or other action model(s). For instance, action models 154/154A can include one or more of an RL policy machine learning (ML) model, an action sequence ML model, a constraint satisfaction model, a SAT solver, and/or other model(s).

In some implementations, selection engine 126/126A can interact with embedding engine 122/122A in dictating which embedding technique is being utilized by embedding engine 122/122A at a given instance and/or can interact with action engine 124/124A in dictating which action model(s) are being utilized by global action engine 124/124A at a given instance. For example, selection engine 126/126A can dictate that embedding engine 122/122A utilize a first embedding technique initially. Then, if evaluation engine 130/130A indicates, e.g., based on feedback from a user, that corresponding set(s) of computer-based interactions generated based on the first embedding technique are unsuitably abstract, selection engine 126/126A can dictate that embedding engine 122/122A utilize a second embedding technique in generating additional embedding(s). As another example, selection engine 126/126A can dictate that embedding engine 122/122A utilize a first embedding technique and a second embedding technique initially. Then, only if evaluation engine 130/130A indicates that corresponding candidate synthetic sets of computer-based interactions generated based on the first embedding technique and the second embedding technique are unsuitable, selection engine 126/126A can dictate that embedding engine 122/122A utilize a third and/or a fourth embedding technique in generating additional embedding(s).

In some implementations, selection engine 126/126A can optionally utilize one or more selection models 156/156A in determining which embedding technique(s) and/or action(s) to utilize at a given instance. For example, selection model(s) 156/156A can include a selection ML model that can be used to process a domain of a task and/or NL input data that requests the task (e.g., an embedding of the NL input data) and to generate output that indicates a corresponding probability for each of a plurality of embedding technique(s) and/or action model(s). Selection engine 126/126A can utilize the generated output in selecting which embedding technique(s) and/or action model(s) to utilize. For example, selection engine 126/126A can use the output to select a highest probability embedding technique and/or a highest probability action model for utilization initially. Such a selection ML model can be trained, for example, based on supervised training examples that are based on past sets of computer-based interactions that are determined to be suitably abstract (and optionally confirmed as suitable after real-world implementation thereof).

SIM engine 128/128A can be used, for each of the sets of computer-based interactions generated by action engine 124, to simulate implementation of the set of computer-based interactions in a simulated environment, such as a simulated environment that reflects a current state of the domain. Further, the SIM engine 128/128A generates simulation data for each of the simulations. In some situations, an action set can be generated during the simulation via the SIM engine 128. For example, some RL policy models can be utilized, in simulation, to generate a set of computer-based interactions, which will be implemented during the simulation and its generation will be dependent on simulated states encountered during the simulation.

Evaluation engine 130/130A can determine whether a candidate synthetic set of computer-based interactions is suitably abstract and/or determine, from amongst multiple candidate synthetic sets of computer-based interactions, a most suitably abstract of the candidate synthetic sets. In various implementations of utilizing simulation data in evaluating a candidate synthetic set of computer-based interactions, evaluation engine 130/130A can solicit and/or utilize user feedback based on the simulation data. For example, the evaluation engine 130/130A can cause simulation data, from the simulation, to be rendered to a user from which a set of observed computer-based interactions was recorded, and determine suitability based on feedback from the user in response to the rendering. For example, the evaluation engine 130/130A can cause a screenshot, final state, video, etc. of the simulated environment in its final state from a simulation to be rendered at the client 110. In response, the user can provide user interface input(s) that reflect whether the output is sufficiently abstract to preserve the user's privacy, e.g., while continuing to be suitable for automating the higher-level task at large. The evaluation engine 130/130A can use instances of negative feedback to eliminate a corresponding candidate synthetic set of computer-based interactions or to negatively impact a suitability metric for the candidate synthetic set. In contrast, the evaluation engine 130/130A can use instances of positive feedback to select a candidate synthetic set of computer-based interactions as most suitable, or to positively impact a suitability metric for the corresponding candidate synthetic set. In various implementations, in evaluating a synthetic set of computer-based interactions, evaluation engine 130/130A utilizes simulation data from the simulation of the action set by SIM engine 128.

In some of those implementations, evaluation engine 130/130A can compare the simulation data to one or more state rules 160/160A, which can be used to determine that a candidate action set is unsuitable and/or to negatively impact a suitability score, for the candidate action set, that is utilized in determining suitability of the candidate action set. The state rules 160/160A can be specific to a domain and/or specific to a corresponding requesting entity, such as a user providing or an organization associated with the user. For example, for a particular domain and a particular organization, a given state rule (e.g., predefined or provided by a user as feedback) can define that a given state should never be encountered or that a particular sequence of states should never be encountered. If simulation data, from simulation of a candidate action set, indicates that the given state and/or the particular sequence of states was encountered, evaluation engine 130/130A can determine that candidate action set is unsuitable. As another example, for a particular domain and a particular organization, a given state rule can define that a given state or a particular sequence of states is undesirable, but not prohibited. If simulation data, from simulation of a candidate action set, indicates that the given state and/or the particular sequence of states was encountered, evaluation engine 130/130A can negatively impact a suitability metric for the candidate action set.

Machine learning models described herein can be of various architectures and trained in various manners. For example, one or more of the models can be a graph-based neural network (e.g., as a graph neural network (GNN), graph attention neural network (GANN), or graph convolutional neural network (GCN)), a sequence-to-sequence neural network such as a transformer, an encoder-decoder, or a recurrent neural network (“RNN”, e.g., long short-term memory, or “LSTM”, gate recurrent units, or “GRU”, etc.), a BERT (Bidirectional Encoder Representations from Transformers), and so forth. Also, for example, reinforcement learning, supervised learning, and/or imitation learning can be utilized in training one or more of the machine learning models. Additional description of some implementations of various machine learning models is provided herein.

To summarize FIG. 1, the global (or “public”) engines 122, 124, 126, 128, and/or 130 may be used to, for instance, select from multiple different candidate synthetic sets of computer-based interactions for real-world implementation, e.g., in response to user requests to perform various high-level tasks. Additionally, one or more of global engines 122, 124, 126, 128, and/or 130 may facilitate federated learning of one or more models 152, 154, 156 based on local model parameters/local gradients received from private (or “local”) engines 122A, 124A, 126A, 128A, and/or 130A. For their part, private (or “local”) engines 122A, 124A, 126A, 128A, and/or 130A may facilitate generation and distribution of these local model parameters/local gradients based on user feedback provided about simulation of synthetic computer-based interactions at various levels of abstraction.

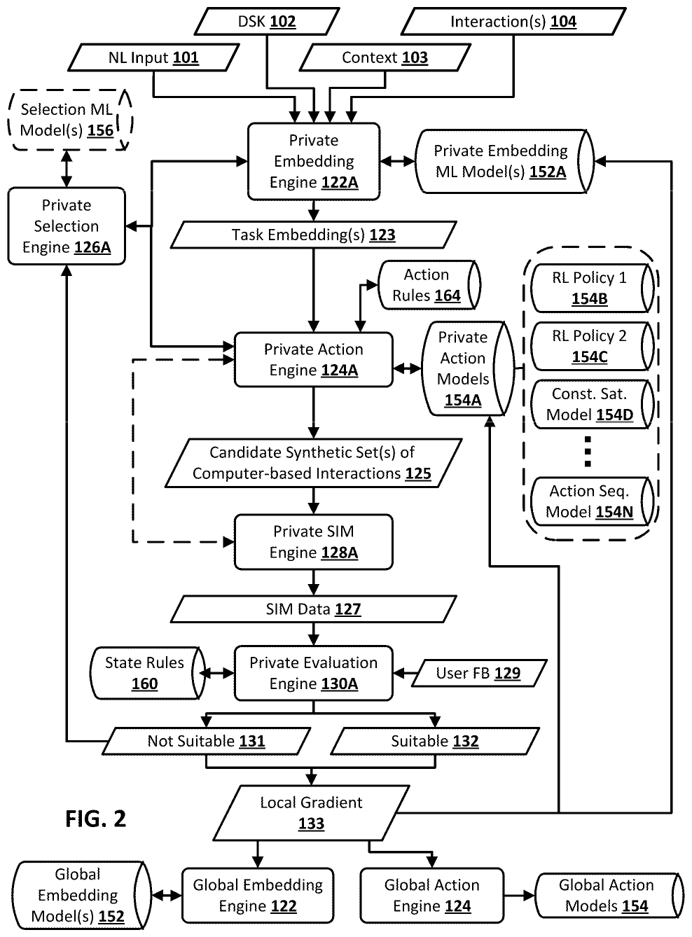

Turning to FIG. 2, description is provided of examples of: the engines 122A, 124A, 126A, 128A, and 130A of task automation system 120 as implemented at client device 110 for purposes of federated learning. FIG. 2 also depicts the interactions that can occur amongst those engines, the models 152A, 154A, and 156A, and the rules 160A and 164A (which in some cases may be the same as 160 and 164) that can be utilized by client 110 to facilitate federated learning.

In FIG. 2, private embedding engine 122A processes various data, such as data indicative of observed computer-based interactions (“interactions”) 104 and, in some instances, NL input 101. Based on this data, private embedding engine 122A generates a task embedding 123. Domain-specific knowledge (DSK) 102 may include, for instance, various reference documents or other supplemental data that can, for instance, be provided as additional inputs to effectively “condition” or “prime” models (e.g., 152A, 154A), e.g., akin to few shot learning (except the model weights may or may not be tuned). Context 103 can include a wide variety of data points, such as signals generated by client 110 (e.g., position coordinates, time-of-day, foreground and/or background applications, other sensor signals, etc.), user preferences, user areas of expertise (e.g., expert in physics, expert in biology, etc.), and so forth.

Data 104 may include any data that is recorded to document computing interactions between a user and one or more computer applications operated on client device 110. In some implementations, data 104 may include hardware inputs such as keystrokes, pointer device movements and/or actions (e.g., clicks, right clicks, scrolls, etc.), and so forth. In some implementations, data 104 may include application-specific interactions such as interactions with graphical elements and/or menu items, sequences of input commands (including NL input(s) 101 provided to interact with one or more computer applications), rendered audible and/or visual outputs, and so forth.

In some implementations, data 104 may include application-specific computer code, such as code that may be generated in some applications (e.g., word processing, spreadsheets, etc.) when a user opts to record a “macro.” In some implementations, data 104 may include information input by a user, such as information used to compose a document (e.g., letter, email, report), information used to populate a spreadsheet, information used to populate a form (e.g., a webpage or part of an application), information used to create a graphic design or drawing, information exchanged with a virtual assistant, and so forth.

Whichever the case, private embedding engine 122A may process data 104 (and other data 101-103 where applicable) to generate one or more task embeddings 123. In some implementations, task embedding(s) 123 may include separate tokens/embeddings that encode each interaction (e.g., input from the user, output from the computer application). In some implementations, multiple interactions may be combined (e.g., aggregated, concatenated) into a semantically rich task embedding 123 that represents a plurality of interactions.

The NL input 101 (which is optional and/or may be recorded as part or, or separately from, data 104) may be provided by a user via interaction with user interface input device(s) of a client device (e.g., client 110 of FIG. 1). For example, the user may provide a NL input 101 such as “I'm going to draft a letter now. Please record my actions so we can automate this process moving forward.” In some instances, the NL input 101 can be spoken input, of the user, that is detected via microphone(s) of the client 110. Private embedding engine 122A may process recognized text, generated based on the spoken input (e.g., using automatic speech recognition (ASR)), in generating the task embedding 123. As another example, the NL input 101 can be typed input provided via a virtual or hardware keyboard of the client 110, and the typed text can be processed by private embedding engine 122A in generating the task embedding 123. For instance, the recognized text or typed text can be processed using an NL ML model of ML model(s) 152A, to generate an NL embedding. The NL ML model can be, for example, an LLM. The task embedding 123 can be the NL embedding or can be a function of the NL embedding and other NL embeddings.

Private action engine 124A processes the task embedding 123, using one or more of the action ML models, to generate one or more candidate synthetic sets of computer-based interactions 125. For example, the private action engine 124A can, in a given instance, process task embedding 123 using one of first RL policy model 154B, second RL policy model 154C, constraint satisfaction model 154D, action sequence model 154N, or other model(s) of action models 154 (e.g., other model(s) indicated by the vertical ellipsis in FIG. 2). In some of those implementations, which of the action model(s) 154 is utilized by private action engine 124A at a given instance may be dictated by selection engine 126. In some implementation, action sequence model 154N is a sequence-to-sequence model such as a transformer model (e.g., BERT, GPT, etc.) that can be applied to predict, e.g., iteratively or all at once, a sequence of tokens representing a sequence of computer-based interactions.

Private SIM engine 128A can be used, for each of the candidate synthetic set(s) of computer-based interactions 125, to simulate implementation of the action set in a simulated environment, such as a simulated environment that reflects a current state of the domain. Further, private SIM engine 128A generates simulation (SIM) data 127 for each of the simulations. In some situations, a candidate synthetic set of computer-based interactions of the sets 125 can be generated independent of its simulation, and private SIM engine 128A may be utilized to simulate the action set after the candidate synthetic set of computer-based interactions is generated. In some other situations, a candidate synthetic set of computer-based interactions can be generated by private action engine 124A during the simulation via the private SIM engine 128A. This is reflected by the dashed double arrowed line between private action engine 124A and private SIM engine 128A.

SIM data 127 may be presented (e.g., rendered) to a user, e.g., by private SIM engine 128A or private evaluation engine 130A, so that the user can provide feedback 129. For example, once the user is presented with SIM data 127, e.g., visually (e.g., as an animation, snapshot of a current or final state of the domain, final document, etc.) and/or audibly, the user may be prompted to provide feedback 129 that accepts, rejects, and/or modifies level(s) of abstraction of one or more computer-based interactions of the candidate synthetic set of computer-based interactions 125. This may allow the user to control how much personal and/or sensitive information is provided to untrusted and/or public entities.

Private evaluation engine 130A can determine, based on the user feedback 129, whether a corresponding candidate action set, of the candidate synthetic set(s) of computer-based interactions 125, is suitably abstract for preserving the user's privacy and/or determine, from amongst multiple candidate synthetic sets of computer-based interactions, a most suitably abstract of the candidate synthetic sets of computer-based interactions. In some of those implementations, private evaluation engine 130A can compare the simulation data to one or more state rules 160A, which can be used to determine that a candidate synthetic set of computer-based interactions is unsuitably abstract (e.g., too specific, contains personal data, not widely applicable) and/or to negatively impact a suitability score that is utilized in determining suitability of the candidate synthetic set of computer-based interactions.

If private evaluation engine 130A determines, e.g., based on user feedback 129, that none of the candidate synthetic set(s) of computer-based interactions 125 is suitable, it can output a not suitable indication 131 to private selection engine 126A. In response, private selection engine 126A can adapt the embedding technique utilized by private embedding engine 122A and/or the private action model(s) 154A being utilized by private action engine 124A. Further candidate synthetic set(s) of computer-based interactions 125 can then be generated based on a different task embedding 123 (e.g., generated using an alternate embedding technique) and/or based on a different action model of the private action model(s) 154A.

For example, private selection engine 126A can adapt the embedding technique being utilized (e.g., by reducing the dimensionality of the embedding), but not adapt the action model(s) 154 being utilized. In response, private embedding engine 122A can generate a different task embedding 123 using the different adapted embedding technique, and private action engine 124A will process the different task embedding 123 utilizing the same action model as before. This can result in generating different candidate synthetic set(s) of computer-based interactions 125 due to the different task embedding 123. The different action set(s) 125 can be simulated by private SIM engine 128A and resulting SIM data 127 utilized by private evaluation engine 130A to allow a user to provide new feedback 129 about the different candidate synthetic set(s) of computer-based interactions 125. Multiple iterations of this can occur until, for example, private evaluation engine 130A and/or user determines an evaluated candidate synthetic set of computer-based interactions is suitable for dissemination to global and/or public entities.

Private evaluation engine 130A (and/or private selection engine 126A) can use other techniques to control a level of abstraction used to automate tasks. In some implementations, based on user feedback 129, private evaluation engine 130A may use various rules and/or heuristics to alter specific pieces of information that are recorded as part of interactions data 104. One example described previously involved a user indicating (as part of feedback 129) that a specific recipient's address should not be used when attempting to automate a letter writing task. As another example, during automation of filling out a webpage form to make a purchase, a user may reject a simulation that presents a candidate synthetic set of computer-based interactions (125) that includes a form field being filled out with a particular credit card number. This may result in the user's credit card number being excluded, obfuscated, replaced with a generic placeholder, etc., before generation, e.g., by private embedding engine 122A, of a new task embedding 122A.

In some implementations, private evaluation engine 130A, private selection engine 126A, and/or private action engine 124A may select a different private action model 154A and/or alter one or more parameters of a particular action model 154A to control/alter a level of abstraction. As one example, the temperature of the action model's softmax layer may be adjusted to alter probability distribution(s) generated by the action model. A “higher” temperature may yield probability distribution(s) that are “softer,” less confident, and/or more uniform, whereas a “lower” temperature may yield probability distribution(s) that are “harder,” more confident, and/or less uniform. Stochastically sampling from the former may yield more variation (and hence, a different level of abstraction) than the latter.

Referring back to FIG. 2, if the private evaluation engine 130A determines, in a given iteration, that one of the candidate synthetic set(s) of computer-based interactions 125 is suitable (e.g., user feedback 129 indicates the interaction(s) 125 are suitably abstract), private evaluation engine 130A may generate a suitable indication 132. In various implementations, based on the not suitable indication 131 and/or the suitable indication 132, a local gradient 133 may be calculated, e.g., using techniques such as back propagation, gradient descent, cross entropy, etc. As indicated by the arrows, local gradient 133 may then be used to update private embedding ML model(s) 152A and/or private action model(s) 154A. Local gradient 133 and/or the updated parameters of private embedding ML model(s) 152A and/or private action model(s) 154A may then be provided to global embedding engine 122 and/or global action engine 124. Global embedding engine 122 may use local gradient 133 received from multiple different clients 110 to update global embedding model(s) 152 as part of a federated learning framework. Similarly, global action engine 124 may use local gradient 133 received from multiple different clients 110 to update global action model(s) 154 as part of a federated learning framework.

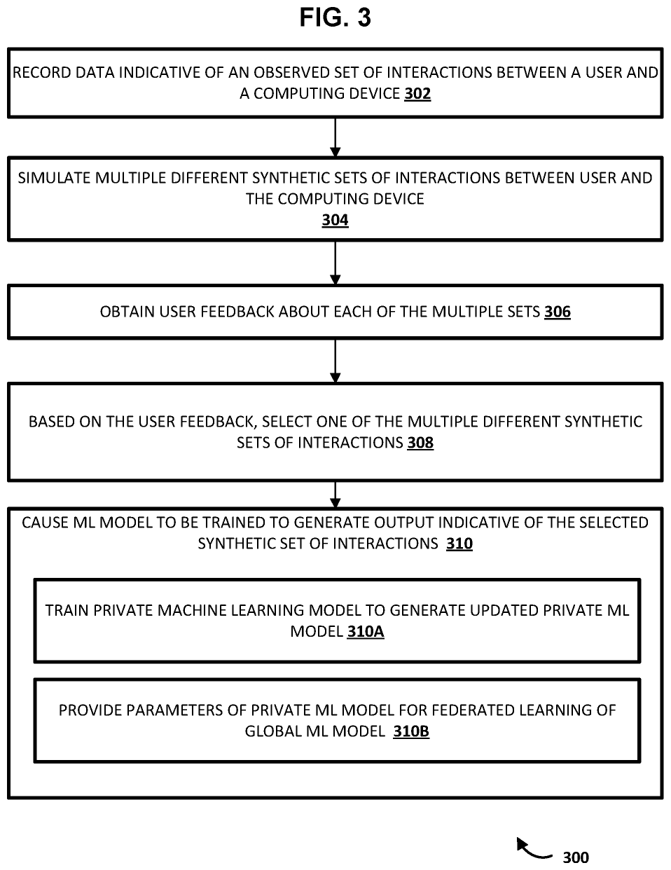

FIG. 3 is a flowchart illustrating an example method 300 for practicing selected aspects of the present disclosure, according to implementations disclosed herein. For convenience, the operations of the flow chart are described with reference to a system that performs the operations. This system may include various components of various computer systems, such as one or more components of task automation system 120. Moreover, while operations of method 300 are shown in a particular order, this is not meant to be limiting. One or more operations may be reordered, omitted or added.

At block 302, the system, e.g., by way of application 112, an operating system, and/or private embedding engine 122A, may record data (e.g., 104) indicative of an observed set of interactions between a user and a computing device. In some implementations this recording may be triggered by a command from the user, which the user may issue using various types of input (e.g., keyboard input, pointer device input, voice input, etc.). In other implementations, this recording may be triggered automatically, e.g., in response to detecting the user performing some number of actions repeatedly. For example, if the user performs multiple sequences of mostly similar actions repeatedly, an agent such as a virtual assistant or application assistant configured with selected aspects of the present disclosure may issue a prompt, such as “I see that you're [INSERT TASK NAME] again. Would you like me to generate an automated routine to perform those steps for you in the future?”

Based on the recorded data, at block 304, the system, e.g., by way of private SIM engine 128A, may simulate multiple different synthetic sets of interactions between the user and the computing device. Each synthetic set of computer-based interactions may be a variation of the observed set of interactions at a different level of abstraction. In some implementations, the simulation of block 304 may be based on a machine learning model. The machine learning model may be private action model(s) 154A that are trained to generate probability distribution(s) over an action space, such as the action space of the domain (e.g., word processing, graphic design, web browsing, spreadsheet manipulation, etc.) in which the user is operating.

For instance, RL policies 154B and/or 154C may generate, at each iteration based on a current state of the domain, a probability distribution over the action space of the domain. Based on that probability distribution, one or more next actions may be selected and simulated, and the process may repeat. Similarly, action sequence model 154N may be a sequence-to-sequence model that generates, e.g., at all once, a sequence of tokens, each representing one or more actions in the domain's action space. In some such implementations, each token may include a probability distribution over multiple different actions. In other such implementations, the whole sequence may be assembled based on probability distributions and then simulated.

Suppose the repetitive task is composing a letter. The user may be presented with one simulation in which the recipient street address is omitted or replaced with a placeholder but the city and/or state of the recipient is preserved, another simulation in which the recipient address (including the city and state) is wholly omitted or replaced with a placeholder, and so forth. Yet other simulations may abstract away all or parts of the body of the letter, the sender address, and so forth.

Suppose the repetitive task is preparing and/or organizing a spreadsheet to make some number of calculations based on data contained in an input range of cells to populate an output range of cells. One simulation may include the specific values in the input range of cells and the formulas used to populate the output range of cells. Another simulation may not include specific values, or may include obfuscated or random values, in the input range of cells, but may still populate the output range of cells with the same formulas used by the user. Yet another simulation may only include general formatting employed by the user in the original spreadsheet, without including any of the data used or calculated for the user.

At block 306, the system, e.g., by way of private evaluation engine 130A, may obtain user feedback about each of the multiple different sets. In some implementations, this feedback may be obtained (e.g., the user may be prompted to provide it) after each simulation, in which case further simulations may not be performed once the user accepts the latest simulation. In other implementations, the user may be presented with multiple simulations before feedback is obtained. In the latter case, the user may identify one or more of the simulations that were satisfactory and/or one or more of the simulations that were not (e.g., because it would potentially divulge sensitive or private information).

Based on the user feedback obtained at block 306, at block 308, the system, e.g., by way of private evaluation engine 130A, may select one of the multiple different synthetic sets of interactions. For example, once the user is presented with a satisfactory simulation that the user is comfortable with that will not result in the inadvertent disclosure of sensitive (or more generally, not broadly applicable) information, the user may accept the simulation.

At block 310, the system may cause a machine learning model to be trained to generate output indicative of the selected synthetic set of interactions. For example, at block 310A, private evaluation engine 130A, private embedding engine 122A, and/or private action engine 124A may train private embedding ML model(s) 152A and/or private action model(s) 154A. At block 310B, private evaluation engine 130A, private embedding engine 122A, and/or private action engine 124A may provide parameters (e.g., a local gradient) of one or more of the private ML models 152A, 154A to global embedding engine 122 and/or global action engine 124 for federated learning of global embedding ML model(s) 152 and/or global action ML model(s) 154. When combined with other local gradients, the resulting global embedding ML model(s) 152 and/or global action ML model(s) 154 may be distributed to other clients to facilitate automation of tasks.

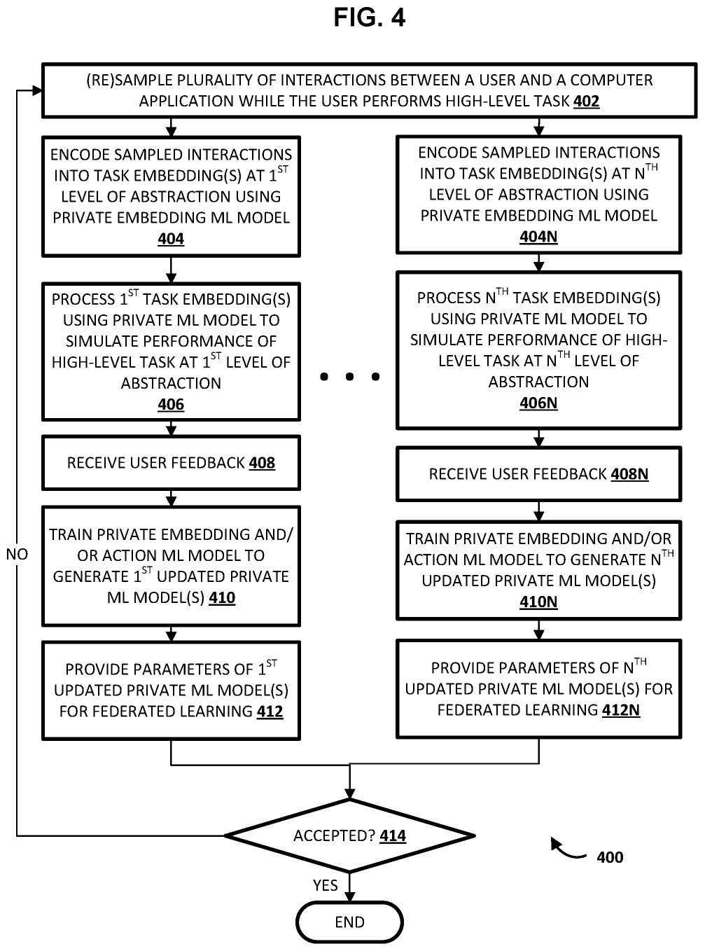

FIG. 4 is a flowchart illustrating another example method 400 for practicing selected aspects of the present disclosure, according to implementations disclosed herein. For convenience, the operations of the flow chart are described with reference to a system that performs the operations. This system may include various components of various computer systems, such as one or more components of task automation system 120. Moreover, while operations of method 400 are shown in a particular order, this is not meant to be limiting. One or more operations may be reordered, omitted or added.

At block 402, the system, e.g., by way of private embedding engine 122A, may sample (e.g., record) a plurality of interactions between a user and a computer application. The interactions may be collectively associated with the user performing a high-level task, such as composing a letter, reading an academic article (e.g., within or outside of the user's expertise), manipulating a spreadsheet or other document, etc.

At block 404, the system, e.g., by way of private embedding engine 122A, may encode the plurality of interactions into a first task embedding at a first level of abstraction. In some such implementations, private embedding engine 122A may utilize one or more private embedding ML model(s) 152A to perform the encoding of block 404. These private embedding ML model(s) 152A may be selected by private selection engine 126A, e.g., based on context 103, interaction(s) data 104, NL input 101 (if present), DSK 102, and so forth.

At block 406, the system, e.g., by way of private action engine 124A and/or private SIM engine 128A (which in some cases may be combined into a single unit), may process the first task embedding using a private machine learning model (e.g., 154A) to simulate, for the user via one or more output devices, performance of the high-level task at the first level of abstraction.

At block 408, the system, e.g., by way of private SIM engine 128A and/or private evaluation engine 130A, may receive user feedback, prompted or unsolicited. If the user feedback includes a rejection of the first level of abstraction, at block 410, private embedding ML model(s) 152A and/or private action ML model(s) 154A may be trained, e.g., by private evaluation engine 130A and/or private action engine 124A, resulting in a first updated private ML model being generated.

At block 412, the system, e.g., by way of private action engine 124A and/or private evaluation engine 130A, may provide parameters of the first updated private machine learning model, e.g., to global embedding engine 122 and/or global action engine 124, for federated learning of global embedding ML model(s) 152 and/or global action ML model(s) 154.

At block 414, the system, e.g., by way of private evaluation engine 130A, may determine whether the user accepted or rejected the simulated performance of the high-level task at the first level of abstraction. If the answer is yes, then method 400 may end. However, if the answer at block 414 is no, then method 400 may proceed back to block 402 and the process may repeat. For example, in response to the user input rejecting the first level of abstraction, the same sampled plurality of interactions or a different sampled plurality of interactions (e.g., where the user rejects specific interaction(s)) may be encoded, e.g., by private embedding engine 122A, into a second task embedding at a second level of abstraction that is different than the first level of abstraction. The second task embedding may be used to simulate, for the user via one or more of the output devices, performance of the high-level task at the second level of abstraction. The process may repeat as described previously for N iterations, as depicted in FIG. 4.

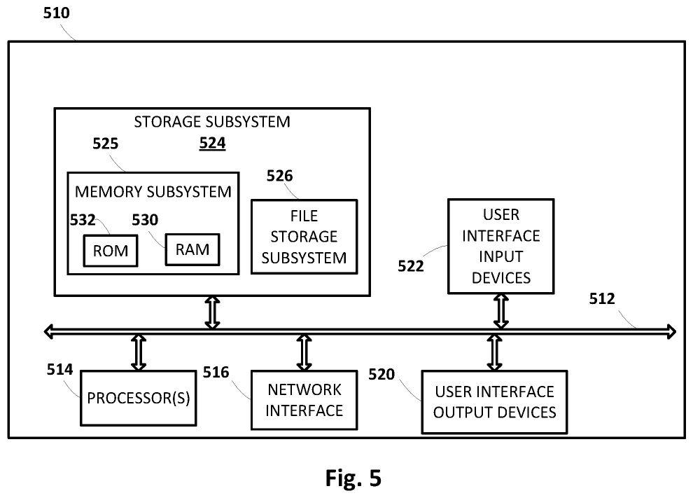

FIG. 5 is a block diagram of an example computing device 510 that may optionally be utilized to perform one or more aspects of techniques described herein. In some implementations, the client device 110, the task automation system 120, and/or other component(s) can comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the method 300 of FIG. 3, the method 400 of FIG. 4, and/or other method(s) described herein.

These software modules are generally executed by processor 514 alone or in combination with other processors. Memory 525 used in the storage subsystem 524 can include a number of memories including a main random access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem may use multiple buses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
sampling a plurality of interactions between a user and a computer application, wherein the interactions are collectively associated with the user performing a high-level task;
encoding the plurality of interactions into one or more first task embeddings at a first level of abstraction;
processing one or more of the first task embeddings using a private machine learning model to simulate, for the user via one or more output devices, performance of the high-level task at the first level of abstraction;
based on user input rejecting the first level of abstraction, training the private machine learning model, wherein the training generates an updated private machine learning model; and
providing parameters of the updated private machine learning model for federated learning of a global machine learning model.

2. The method of claim 1, further comprising:
in response to the user input rejecting the first level of abstraction, encoding the plurality of interactions into one or more second task embeddings at a second level of abstraction that is different than the first level of abstraction; and
prior to the training, processing one or more of the second task embeddings using the private machine learning model to simulate, for the user via one or more of the output devices, performance of the high-level task at the second level of abstraction.

3. The method of claim 2, wherein the simulated performance of the high-level task at the second level of abstraction excludes one or more interactions of the sampled plurality of interactions.

4. The method of claim 2, wherein the simulated performance of the high-level tasks at the second level of abstraction excludes or obfuscates one or more pieces of information that was input by, or output to, the user during the sampling.

5. The method of claim 2, wherein a different softmax layer temperature is used to encode the first task embedding(s) than is used to encode the second task embedding(s).

6. The method of claim 1, wherein the providing includes providing data indicative of a local gradient to a remote computing system that maintains the global machine learning model.

7. The method of claim 1, wherein the private machine learning model comprises a transformer.

8. The method of claim 1, wherein the private machine learning model comprises a large language model (LLM).

9. The method of claim 8, wherein tokens predicted based on the LLM correspond to the first plurality of interactions.

10. A method implemented using one or more processors and comprising:
recording data indicative of an observed set of interactions between a user and a computing device;
based on the recorded data, simulating multiple different synthetic sets of interactions between the user and the computing device, wherein each synthetic set comprises a variation of the observed set of interactions at a different level of abstraction;
obtaining user feedback about each of the multiple different synthetic sets of interactions;
based on the user feedback, selecting one of the multiple different synthetic sets of interactions; and
causing a machine learning model to be trained to generate output indicative of the selected synthetic set of interactions.

11. The method of claim 10, wherein the simulating is performed based on the machine learning model.

12. The method of claim 11, wherein the machine learning model is trained to facilitate intelligent process automation.

13. The method of claim 11, wherein the machine learning model is trained to generate a probability distribution over an action space.

14. The method of claim 11, wherein the machine learning model comprises a private machine learning model, and the method further comprises providing parameters of the trained private machine learning model for federated learning of a global machine learning model.

15. A system comprising one or more processors and memory storing instructions that, in response to execution by the one or more processors, cause the one or more processors to:
record data indicative of an observed set of interactions between a user and a computing device;
based on the recorded data, simulate multiple different synthetic sets of interactions between the user and the computing device, wherein each synthetic set comprises a variation of the observed set of interactions at a different level of abstraction;
obtain user feedback about each of the multiple different sets;
based on the user feedback, select one of the multiple different synthetic sets of interactions; and
cause a machine learning model to be trained to generate output indicative of the selected synthetic set of interactions.

16. The system of claim 15, wherein the machine learning model is used to simulate the multiple different synthetic sets of interactions between the user and the computing device.

17. The system of claim 15, wherein the machine learning model is trained to facilitate intelligent process automation.

18. The system of claim 15, wherein the machine learning model is trained to generate a probability distribution over an action space.

19. The system of claim 15, wherein the machine learning model comprises a private machine learning model.

20. The system of claim 19, further comprising instructions to provide parameters of the trained private machine learning model for federated learning of a global machine learning model.
